(19) United States
(12) Patent Application Publication
(10) Pub. No.: US 2007/0080550 A1
(43) Pub. Date: Apr. 12, 2007

(54) Problem solver-flexible steel fifth wheel pin release handle

(76) Inventor: Quadir Nuriddin, Elizabeth, NJ (US)

Correspondence Address: Rashid Management and Planning, 1144 Clinton Avenue, Irvington, NJ, 07111, US

(21) Appl. No.: 11/246,053

(22) Filed: Oct. 11, 2005

(51) Int. Cl. B66C 1/34

(52) U.S. Cl. 294/82.11

(57) ABSTRACT

The ‘problem solver’ flexible pin release handle is a manual release contraption Attachable to a fifth wheel of a truck cab for disengaging a tractor or truck trailer from the fifth wheel, including the elongated, rigid lever arm, which is pivotally attached to a side of the fifth wheel at a location spaced from the opening through which the release rod extends, a second end of which is spaced away from the fifth wheel extended horizontally from the first end thereby causing the release rod to be pulled outwardly to disengage the king pin from the fifth wheel.

### BACKGROUND OF THE INVENTION

this invention is in the field of fifth wheel semi-trailer vehicles and in particular the attachment and release of such semi-trailers from a towing vehicle.

semi-trailers are most commonly hitched to high-way tractors by means of a fifth wheel hitch. The fifth wheel hitch assembly comprises an upper portion attached to the semi-trailer, comprising an upper plate with a pin extending down from the center of the plate, and a lower portion attached to the tractor comprising a lower plate with a slot extending rearward. To connect the semi-trailer, the tractor is backed up so that the pin passes through the slot and is locked into the end of the slot. To disconnect the semi-trailer, a lock release lever must be pulled in a direction generally lateral toward the left driver's side of the semi-trailer to release the pin so that the tractor can be moved ahead and out of engagement with the semi-trailer. It can take considerable force to move the lock release lever and release the pin on the semi-trailer.

the lock release lever is located on the lower portion of the hitch assembly under the front end of the semi-trailer. Typically the operator must stretch to reach the lock release lever. A jerking motion is preferred however it is difficult to jerk the lock release because of its position. Rigid extensions are commercially available that comprise a long shaft with a hook on the end to engage the lock release lever. Only a small jerking action on the lock release lever is possible by moving the hook past the lock release lever and then jerking it towards the operator. Such rigid devices are too long to conveniently store in the compartment boxes usually available on highway tractors.

More importantly, in the tractor and semi-trailer assembly, the fifth wheel is the connecting device to the tractor unit which grasps and locks onto the kingpin of the trailer unit. The fifth wheel permits horizontal motion; the kingpin swivels freely as the weight of the trailer rests on the flat bearing plate, allowing the truck and trailer to flex and negotiate turns. The fifth wheel also pivots in the vertical plane, permitting independent flexing of the two units over uneven and hilly road surfaces.

### SUMMARY OF THE INVENTION

The functionality of the problem solver-flexible steel fifth wheel pin ‘release handle’ is to provide a much improved device for moving a lock release lever on the fifth wheel hitch assembly to disconnect a semi-trailer from a tractor

it is further object of the invention to provide such a device that can be readily attached and removed from a front end of the trailer, and allows a novice operator to move to a position beside the semi-trailer and jerk the lock release lever.

the invention provides, in a first aspect, a device for releasing a trailer from a fifth wheel hitch assembly. The flexible steel device comprises a strong member adapted at a first end to release and engage a lock release lever of the fifth wheel hitch assembly, the rigid member having a length sufficient to allow an operator to engage the first end with the lock release lever while grasping a second end of the rigid member and while standing at a front end of the trailer attached to the fifth wheel hitch assembly. A flexible holding rod is attached at a first end thereof to the second end of the rigid member, wherein the rod is non-resilient such that same is resistant to stretching. A loop handle is attached to a second end of the bind, and the bind has a length sufficient to allow the operator to grasp the handle from a duel position beside the trailer with the predetermined slack in the bind such that the operator can jerk the handle to move the lock release lever to a released position.

this invention provides, in a second aspect, a method of releasing a trailer from a fifth wheel hitch assembly. The method comprises providing a rigid member adapted at a first end to release engaged lock release lever of the fifth wheel hitch assembly; attaching a first end of a flexible tether to a second end of the flexible tether to a handle, wherein the flexible tether is non-resilient such that same is resistant to stretching; clasping a second end of the rigid member and engaging the first end of the rigid member with the lock release lever while standing at a front end of a trailer attached to the fifth wheel hitch assembly; sliding a grasping hand along the tether to the handle while moving to a side of the trailer; grasping the handle and moving the handle toward the rigid member to provide a predetermined amount of slack in the tether.

the problem solver flexible steel fifth wheel pin will consist of a ring handle, flexible steel cable, and clamps that will not stretch. A firm pull is required, and the flexible fifth wheel pin release will absorb longitudinally instead of jerking and becoming unattached to the fifth wheel.

### DETAILED DESCRIPTION OF THE FIGURES

While this invention is claimed in the concluding portions hereof, the preferred embodiments are provided in the accompanying detailed description which may be most understood in conjunction with the accompanying diagrams where like parts in each of the several diagrams are labeled with like numbers, and are:

### DETAILED DESCRIPTION

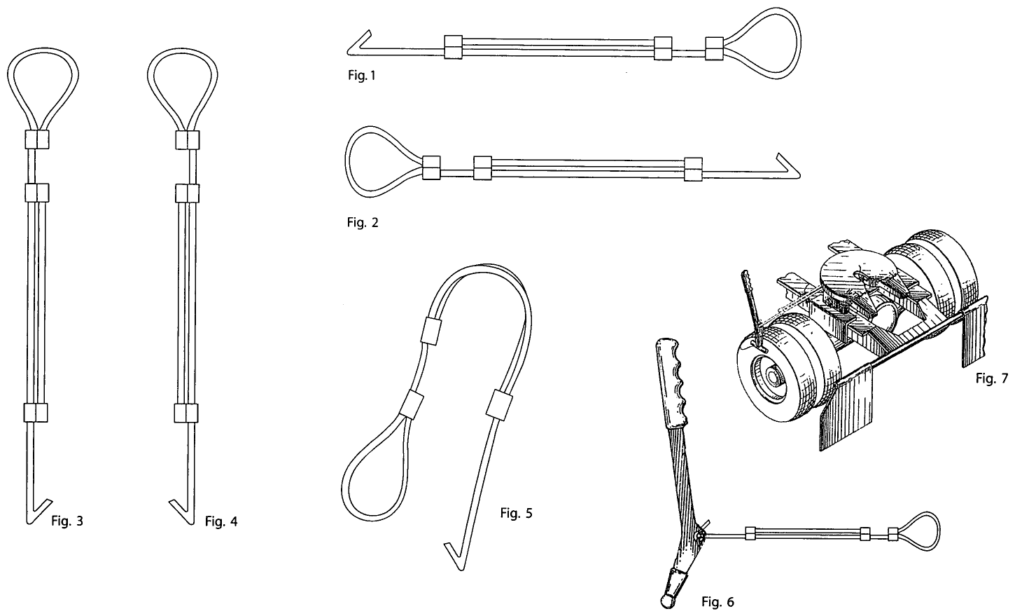

FIG. 1 is a top plan view of the ‘problem solver’ flex bar highlighting the ‘hook’ portion of the invention

FIG. 2 is a top view of the embodiment inverted

FIG. 3 is an alternate front elevation view

FIG. 4 is an alternate front elevation view

FIG. 5 is a schematic ‘flexible’ view of the apparatus

FIG. 6 is the view with the problem solver flexible steel rod connected and the carriage latch released thereby

FIG. 7 is the fifth wheel adjusted to its rearward position

### DETAILED DESCRIPTION OF THE INVENTION

these invention schematics are consistent with the standard industry schematic of fifth wheel mountings. The problem solver-flexible steel fifth wheel pin ‘release handle’ will be able to synergistically join to solidify good results with any fifth wheel that is mounted on either a base plate or a sub chassis with the following specs:
1. There should be at least 5 mm clearance between the base plate/sub chassis and chassis flange
2. If the base plate is made of flat plate, it must be at least 12 mm thick. If a ‘ripple’ plate is used, it must be at least 8 mm thick and have other consistent dimensions
3. There should be at least four M20 (¾ inch) or six M16 (⅝ inch) bolts per side. It is also recommended that M20 bolts be used with chassis having double web thickness and M16 bolts be used on single web thickness.
4. The bolt spacing must be within the range:
   a. M16: 100 to 225 mm
   b. M20: 100 to 300 mmj
   c. The bolt suitability must be grade 8.8 or stronger

this invention disclosed herein provides a device for releasing a trailer from a fifth wheel hitch assembly comprising: A rigid member adapted at a first end to reasonably engage a lock release lever of the fifth wheel hitch assembly, the rigid member having a length sufficient to allow an operator to engage the first end with the lock release lever while grasping a second end of the rigid member and while standing at a front end of a trailer attached to the fifth wheel hitch assembly; a flexible tether attached at a first end thereof to the second end of the rigid member, wherein the tether is a non-resilient such that same is resistant to stretching; a ring handle attached to a second end of the tether, and the tether having a length sufficient to allow the operator to grasp the handle from a position beside the trailer with at least some predetermined slack in the tether such that the operator can jerk the handle to move the lock release lever to a released position.

in an embodiment, the problem solver fifth wheel flexible steel pin release, comprises of a flexible steel ring handle, flexible rod and clamps. In the further embodiment, the handle comprises an elongate bar, and wherein the flexible tether is attached to a high-point of the bar.

this invention also provides an efficient method of releasing a trailer from a fifth wheel hitch assembly

FIGS. 1 and 2 illustrate an embodiment of the invention, a device for releasing a trailer from a fifth wheel hitch assembly. The device is shown in FIG. 6 in use on a fifth wheel hitch assembly.

A rigid member 2 is adapted at a first end 6 to engage the lock release lever of the fifth wheel hitch assembly as indicated with the hook in illustration. The rigid member is long enough to allow the operator to hold the second end of the rigid member and reach in from the front of the semi-trailer and engage the hook with the lock release lever as indicated in FIG. 6. To release the lock release lever, it is conducive to pull it away from the fifth wheel hitch assembly.

Good results have been obtained with a rigid member of about 28 inches in length, and a rodibar of about 8 to 18 inches in length. The rigid member is long enough to allow the operator to conveniently engage the hook on the lock release lever while standing at the front of the trailer. When in the releasing position the handle is then conveniently under the semi-trailer for the operator to jerk the apparatus. The dimensions can be adjusted to suit individual operator preferences. In the illustrated embodiments the handle is a ring with substantial circular design for comfortable grasping.

the trailer is released from the fifth wheel hitch assembly by grasping the second end of the rigid member and engaging the first end with the lock release lever while standing at a front end of a trailer attached to the fifth wheel hitch assembly; then sliding a grasping hand along the rod to the ring handle while moving to a side of the trailer; then grasping the handle with two hands to provide additional force, and moving the handle toward the rigid member to provide at least some slack in the flexible rod; then jerking the handle away from the rigid member thereby moving the lock release lever to the released position.

the storage of this device can be placed in any standard sized tool box

the foregoing is deemed as illustrative purposes only of the principles of the invention. Further, since numerous changes and modifications will readily occur to those skilled in the art, it is not desired at this time to limit the invention to the exact construction and operation shown and described, and accordingly, all such suitable changes or modifications in structure or operation which may be resorted to are intended to fall within the scope of the claimed invention.

### BACKGROUND OF THE INVENTION

This invention is in the field of fifth wheel semi-trailer vehicles and in particular the attachment and release of such semi trailers from a towing vehicle.

Semi-trailers are most commonly hitched to high way tractors by means of a fifth wheel hitch. The fifth wheel hitch assembly comprises an upper portion attached to the semi-trailer, comprising an upper plate with a pin extending down from the center of the plate, and a lower portion attached to the tractor comprising a lower plate with a slot extending rearward. To connect the semi-trailer, the tractor is backed up so that the pin passes through the slot and is locked into the end of the slot. To disconnect the semi-trailer, a lock release lever must be pulled in a direction generally lateral toward the left driver's side of the semi-trailer to release the pin so that the tractor can be force to move the lock release lever and release the pin on the semi-trailer.

The lock release lever is located on the lower portion of the hitch assembly under the front end of the semi-trailer. Typically the operator must stretch to reach the lock release lever. A jerking motion is preferred however it is difficult to jerk the lock release because of its position. Rigid extensions are commercially available that comprise a long shaft with a hook on the end to engage the lock release lever. Only a small jerking action on the lock release lever is possible by moving the hook past the lock release lever and then jerking it towards the operator. Such rigid devices are too long to conveniently store in the compartment boxes usually available on highway tractors.

More importantly, in the tractor and semi-trailer assembly, the fifth wheel is the connecting device to the tractor unit which grasps and locks onto the kingpin of the trailer unit. The fifth wheel permits horizontal motion; the kingpin swivels freely as the weight of the trailer rests on the flat bearing plate, allowing the truck and trailer to flex and negotiate turns. The fifth wheel also pivots in the vertical plane, permitting independent flexing of the two units over uneven and hilly road surfaces.

The functionality of the problem solver-flexible steel fifth wheel pin ‘release handle’ is to provide a much improved device for moving a lock release lever on the fifth wheel hitch assembly to disconnect a semi-trailer from a tractor.

It is further object of the invention to provide such a device that can be readily attached and removed from a front end of the trailer, and allows a novice operator to move to a position beside the semi-trailer and jerk the lock release lever.

The invention provides, in a first aspect, a device for releasing a trailer from a fifth wheel hitch assembly. The flexible steel device comprises a strong member adapted at a first end to release and engage a lock release lever of the fifth wheel hitch assembly, the rigid member having a length sufficient to allow an operator to engage the first end with the lock release lever while grasping a second end of the rigid member and while standing at a front end of the trailer attached to the fifth wheel hitch assembly. A flexible holding rod is attached at a first end thereof to the second end of the rigid member, wherein the rod is non- resilient such that same is resistant to stretching. A loop handle is attached to a second end to of the bind, and the bind has a length sufficient to allow the operator to grasp the handle from a duel position beside the trailer with the predetermined slack in the bind such that the operator can jerk the handle to move the lock release lever to a released position.

This invention provides, in a second aspect, a aspect, a method of releasing a trailer from a fifth wheel hitch assembly. The method comprises providing a rigid member adapted at a first end to release engaged lock release lever to the fifth wheel hitch assembly; attaching a first end of a flexible tether to a second end of the flexible tether to a handle, wherein the flexible tether is non-resilient such the same is resistant to stretching; clasping a second end of the rigid member and engaging the first end of the rigid member with the lock release lever while standing at a front end of a trailer attached to the fifth wheel hitch assembly; sliding a grasping hand along the tether to the handle while moving to a side of the e trailer; grasping the handle and moving the handle toward the rigid member to provide a predetermined amount of slack in the tether.

The problem soccer flexible steel fifth wheel pin will consist of a ring handle, flexible steel cable, and clamps that will not stretch. A firm pull is required, and the flexible fifth wheel pin release will absorb longitudinally instead of jerking and becoming unattached to the fifth wheel.

### DETAILED DESCRIPTION OF THE FIGURES

While this invention is claimed in the concluding portions hereof, the preferred embodiments are provided in the accompanying detailed description, which may be most understood in conjunction with the accompanying diagrams where like parts in each of the several diagrams are labeled with like numbers, and are:

### DETAILED DESCRIPTION

FIG. 1 is a top plan view of the ‘problem solver’ flex bar highlighting the ‘hook’ portion of the invention

FIG. 2 is a top view of the embodiment inverted

FIG. 3 is an alternate front elevation view

FIG. 4 is an alternate front elevation view

FIG. 5 is a schematic ‘flexible’ view of the apparatus

FIG. 6 is the view with the problem solver flexible steel rod connected and the carriage latch released thereby

FIG. 7 is the fifth wheel adjusted to its rearward position

### DETAILED DESCRIPTION OF THE INVENTION

These invention schematics are consistent with the standard industry schematic of fifth wheel mountings. The problem solver-flexible steel fifth wheel pin ‘release handle’ will be able to synergistically join to solidify good results with any fifth wheel that is mounted on either a base plate or a sub chassis with the following specs:
1. There should be at least 5 mm clearance between the base plate/sub chassis and chassis flange.
2. If the base plate is made of flat plate, it must be at least 12 mm thick. If a ‘ripple’ plate is used, it must be at least 8 mm thick and have other consistent dimensions.
3. There should be at least four M2 (¾) or six m16 (58 inch) bolts per side. It is also recommended that M20 bolts be used with chassis having double web thickness and m16 bolts be used on single web thickness.
4. The bolt spacing must be within the range:
   a. M16: 100 to 225 mm
   b. M20: 100 to 300 mm
   c. The bolt suitability must be grade 8.8 or stronger

This invention disclosed herein provides a device for releasing a trailer from a fifth wheel hitch assembly comprising: A rigid member adapted at a first end to reasonably engage a lock release lever of the fifth wheel hitch assembly, the rigid member having a length sufficient to allow an operator to engage the first end with the lock release lever while grasping a second end of the rigid, member and while standing at a front end of a trailer attached to the fifth wheel hitch assembly; a flexible tether attached at a first end thereof to the second end of the rigid member, wherein the tether is a non-resilient such that same is resistant to stretching; a ring handle attached to a second end of the tether, and the tether having a length sufficient to allow the operator to grasp the handle from a position beside the trailer with at least some predetermined slack in the tether such that the operator can jerk the handle to move the lock release lever to a release position.

In an embodiment, the problem solver fifth wheel flexible steel pin release, comprises of a flexible steel ring handle, flexible rod and clamps. In the further embodiment, the handle comprises an elongate bar, and wherein the flexible tether is attached to a high point of the bar.

This invention also provides an efficient method of releasing a trailer from a fifth wheel hitch assembly

FIGS. 1 and 2 illustrate an embodiment of the invention, a device for releasing a trailer from a fifth wheel hitch assembly. The device is shown in FIG. 6 in use on a fifth wheel hitch assembly.

A rigid member 2 is adapted at a first end 6 to engage the lock release lever of the fifth wheel hitch assembly as indicated with the hook in illustration. The rigid member is long enough to allow the operator to hold the second end of the rigid member and reach in from the front of the semi-trailer and engage the hook with the lock release lever as indicated in FIG. 6 To release the lock release lever, it is conducive to pull it away from the fifth wheel hitch assembly.

Good results have been obtained with a rigid member of about 28 inches in length, and a rod/bar of about 8 to 8 inches in length. The rigid member is long enough allow the operator to conveniently engage the hook on the lock release lever while standing at the front of the trailer. When in the releasing position the handle is then conveniently under the semi-trailer for the operator to jerk the apparatus. The dimensions can be adjusted to suit individual operator preferences; in the illustrated embodiments the handle is a ring with substantial circular design for comfortable grasping.

The trailer is release from the fifth wheel hitch assembly by grasping the second end of the rigid member and engaging the first end with the lock release lever while standing at a front end of a trailer attached to the fifth wheel hitch assembly; then sliding a grasping hand along the rod to the ring handle while moving to a side of the trailer; then grasping the handle with two hands to provide additional force, and moving the handle toward the rigid member to provide at least some slack in the flexible rod; then jerking the handle away from the rigid member thereby moving the lock release lever the released position.

The storage of this device can be placed in any standard sized tool box

The foregoing is deemed as illustrative purposes only of the principles of the invention. Further, since numerous changes and modifications will readily occur to those skilled in the art, it is not desired at this time to limit the invention to the exact construction and operation shown and described , and accordingly, all such suitable changes or modifications in structure of operation which may be restored to are intended to fall within the scope of the claimed invention.

What is claimed is:

1. A device for releasing a trailer from a fifth wheel hitch assembly comprising:
a) The flexible steel fifth wheel pin release handle will not break or bend out of shape if hit by the trailer pin because of flexibility which will result in minimal fifth wheel hitch assembly disengagement when truck treads over hills and uneven surfaces.
b) A rigid member adapted at a first end to releasable engage a lock release lever of the fifth wheel hitch assembly, the rigid member having a length sufficient to allow an operator to engage the first end with the lock release lever while grasping a second end of the rigid member and while standing at a front end of a trailer attached to the fifth wheel assembly.
c) A flexible tether attached at a first end thereof to the second end of the rigid member, wherein the tether is non-resilient such that same is resistant to stretching:
d) A ring handle attached to a second end of the tether, and the tether having a length sufficient to allow the operator to grasp the ring handle form beside the trailer with at lest some slack in the tether so that the operator can jerk the handle to move the lock release lever to a released position.

2. The method of claim wherein the flexible steel fifth wheel pin release comprises one flexible wire cable, a wire ring handle and two clamps.

3. Due to the flexible schematic of the flexible steel fifth wheel pin release handle, the pin will give longitudinally instead of jerking and becoming unattached from the fifth wheel.
